(19) United States
(12) Patent Application Publication
(10) Pub. No.: US 2020/0090643 A1
(43) Pub. Date: Mar. 19, 2020

(54) SPEECH RECOGNITION METHOD AND DEVICE

(71) Applicant: LG ELECTRONICS INC., Seoul (KR)

(72) Inventors: Wonho SHIN, Seoul (KR); Jichan MAENG, Seoul (KR)

(73) Assignee: LG ELECTRONICS INC., Seoul (KR)

(21) Appl. No.: 16/485,398

(22) PCT Filed: Jul. 1, 2019
(86) PCT No.: PCT/KR2019/007959

§ 371 Date: Aug. 12, 2019

(51) Int. Cl. G10L 15/16; G10L 15/07; G10L 15/22; G10L 15/06; G10L 15/30

(52) U.S. Cl. CPC G10L 15/16; G10L 15/07; G10L 2015/088; G10L 15/063; G10L 15/30; G10L 15/22

(57) ABSTRACT

Disclosed is a method of recognizing a voice in a speech recognition device includes receiving a wakeup word in a standby mode; extracting a first characteristic value representing a voice characteristic of the wakeup word from the received word and comparing the extracted first characteristic value with a template DB; wherein the template DB stores identification information including a wakeup word made with a mechanical sound and a second characteristic value representing a voice characteristic of the mechanical sound, and entering, if the template DB does not store the second characteristic value matched to the first characteristic value, a speech recognition mode for speech recognition of a speaker and entering, if the template DB stores the second characteristic value matched to the first characteristic value, the standby mode.

### TECHNICAL FIELD

The present invention relates to a speech recognition method and device, and more particularly, to a speech recognition method and device for distinguishing whether a speaker speaks or a machine speaks.

### BACKGROUND ART

Speech recognition is a process in which a computer interprets a speech language spoken by a person and converts contents thereof to text data. Speech recognition is also referred to as speech-to-text (STT). Speech recognition has attracted attention as a method of inputting a text instead of a keyboard. Speech recognition is applied to a case in which device control and information search is required by a speech, such as robot or telematics.

Such speech recognition technology is widely used in everyday life of actual consumers. According to 2018 Adobe Digital Insight, data of more than 55 billion consumer visits to about 250 US retailers and a survey of 1,000 consumers showed that sales of a voice assistant increased by 103 percent in a fourth quarter of last year, and a research result was announced that more than half of consumers with the voice assistant use the voice assistant at least once in a day.

Speech recognition technology is expected to gradually expand to various fields in line with full-fledged expansion of artificial intelligence (AI) technology and Internet of Things (IoT) technology.

However, as the number of electronic products equipped with voice recognition technology increases, there are unexpected problems. For example, when there are together electronic devices operating on the basis of speech recognition, such as a television, an air conditioner, an air cleaner, and an artificial intelligent speaker in one space, an electronic device having a voice recognition function may operate regardless of the user's intention.

As use of speech recognition is gradually expanded, broadcasting that introduces speech recognition in advertisement and guidance is frequently appeared. The problem is that a possibility of an erroneous operation is increasing through the broadcasting.

As in an example of FIG. 8, it is assumed that a television 1001 and an air conditioner 1002 having a voice recognition function are together installed in a single space 1000s. When a mechanical sound output through a speaker of the television includes a wakeup word, for example, while broadcasting a TV commercial, when a mechanical sound of “Hi, LG, turn on an air conditioner” is transmitted, if an air conditioner having a voice recognition function is in the same space with the television, the air conditioner may perform speech recognition to operate the air conditioner according to a wakeup word of “Hi, LG”. This has been often reported in the real world, and it has been reported that a TV sound is mistaken for an order and the order was made to Amazon.

### DISCLOSURE

### Technical Problem

An object of the present invention is to solve the above-described needs and/or problems.

Further, the present invention is to prevent an electronic product having a voice recognition function from operating regardless of a user's intention.

### Technical Solution

In an embodiment of the present invention, a method of recognizing a voice in a speech recognition device includes receiving a wakeup word in a standby mode; extracting a first characteristic value representing a voice characteristic of the wakeup word from the received word and comparing the extracted first characteristic value with a template DB; wherein the template DB stores identification information including a wakeup word made with a mechanical sound and a second characteristic value representing a voice characteristic of the mechanical sound, and entering, if the template DB does not store the second characteristic value matched to the first characteristic value, a speech recognition mode for speech recognition of a speaker and entering, if the template DB stores the second characteristic value matched to the first characteristic value, the standby mode.

The receiving of a wakeup word may include receiving a peripheral voice through a microphone to input the received voice to a neural network (ANN) model trained to recognize the voice and extracting the wakeup word from the received voice from an output of the ANN model.

The receiving of a wakeup word may include updating the template DB by further including extracting, when the wakeup word is recognized in the mechanical sound, the second characteristic value from the wakeup word of the recognized mechanical sound; and matching the extracted second characteristic value to the wakeup word of the mechanical sound and storing the matched second characteristic value at the template DB.

The mechanical sound may be a voice output from the electronic device, and the electronic device may include at least one of a speech recognition speaker, a television, and a radio.

The speech recognition device may be accessed to an AI device through a 5G wireless communication system that provides a 5^{TH} Generation (5G) service, wherein the 5G service may include a Massive Machine-type Communication (mMTC) service, and transmit voice data received in the speech recognition mode to the AI device through an MTC Physical Uplink Shared Channel (MPUSCH) and/or an MTC Physical Uplink Control Channel (MPUCCH), which are/is a physical resource provided through the mMTC service.

The 5G wireless communication system may provide a system bandwidth related to some resource blocks thereof and include a Narrowband-Internet of Things (NB-IoT) system that provides the mMTC service, perform an initial access procedure to the 5G wireless communication system through an anchor type carrier related to the NB-IoT system, and transmit voice data received in the speech recognition mode to the AI device through a non-anchor type carrier related to the NB-IoT system.

In another embodiment of the present invention, a speech recognition device includes a template DB for storing identification information including a wakeup word made with a mechanical sound and a second characteristic value representing a voice characteristic of the mechanical sound; a microphone for receiving a voice; a processor; and a memory for storing instructions that may be executed by the processor, wherein the processor is configured to receive a wakeup word through the microphone in a standby mode; to extract a first characteristic value from the received wakeup word; and to compare a first characteristic value of the extracted wakeup word with the template DB, to control to enter to a speech recognition mode for voice recognition of a speaker, if the template DB does not store the second characteristic value corresponding to the first characteristic value, and to enter to the standby mode, if the template DB stores the second characteristic value corresponding to the first characteristic value.

### Advantageous Effects

According to an embodiment of the present invention, in a standby mode, it is determined whether a received wakeup word is a mechanical sound or a speaker speech using a stored database in order to know whether the obtained wakeup word is a mechanical sound or a speaker voice and then speech recognition is performed and thus a problem by an error in speech recognition can be prevented.

The effects of the present invention are not limited to the above-described effects and the other effects will be understood by those skilled in the art from the following description.

### DESCRIPTION OF DRAWINGS

FIG. 1 is a block diagram of a wireless communication system to which methods proposed in the present specification may be applied.

FIG. 2 is a diagram illustrating an example of a signal transmitting/receiving method in a wireless communication system.

FIG. 3 illustrates an example of a basic operation of a user terminal and a 5G network in a 5G communication system.

FIG. 4 is a block diagram of a speech recognition device according to an embodiment of the present invention.

FIG. 5 is a flowchart illustrating a speech recognition method according to an embodiment of the present invention.

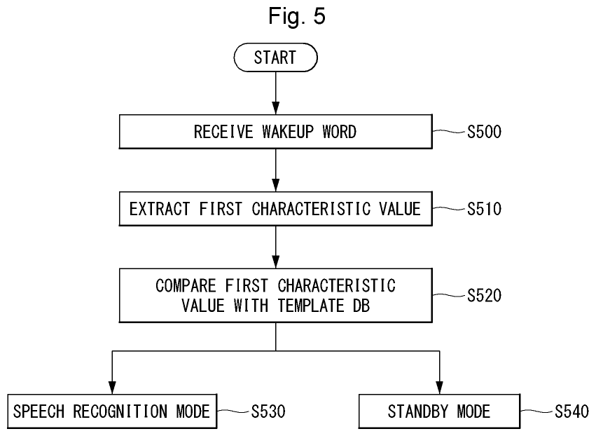

FIG. 6 is a diagram illustrating an example of a template DB.

FIG. 7 is a diagram illustrating a process of updating a template DB.

FIG. 8 is a diagram illustrating an environment in which an error occurs in speech recognition.

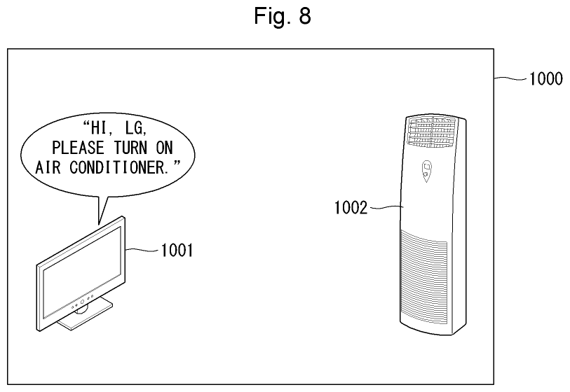

### MODE FOR INVENTION

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

### A. Example of Block Diagram of UE and 5G Network

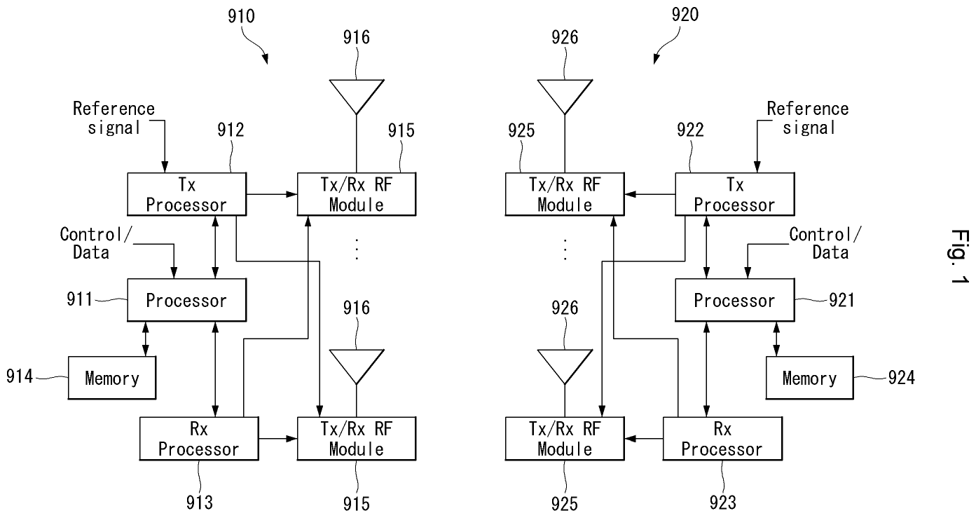

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

### B. Signal Transmission/Reception Method in Wireless Communication System

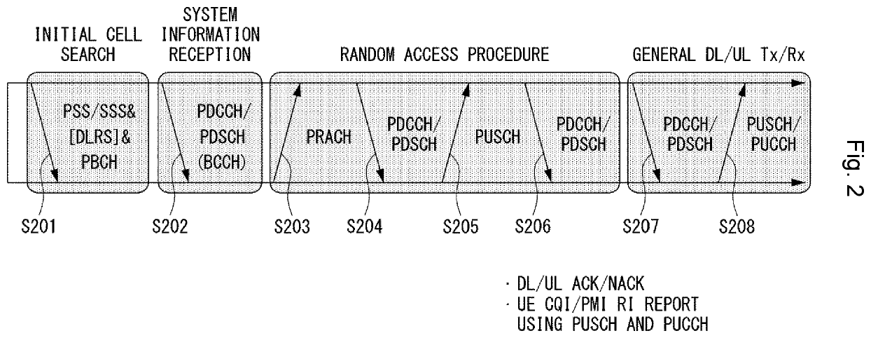

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

### C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSB×1, SSB×, SSB×, SSB×4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

### D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

### E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

### F. Basic Operation Between Autonomous Vehicles Using 5G Communication

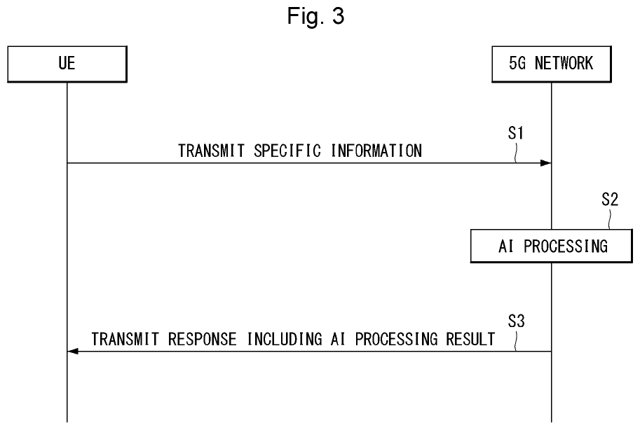

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

### G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present invention which will be described later and applied or can complement the methods proposed in the present invention to make technical features of the methods concrete and clear.

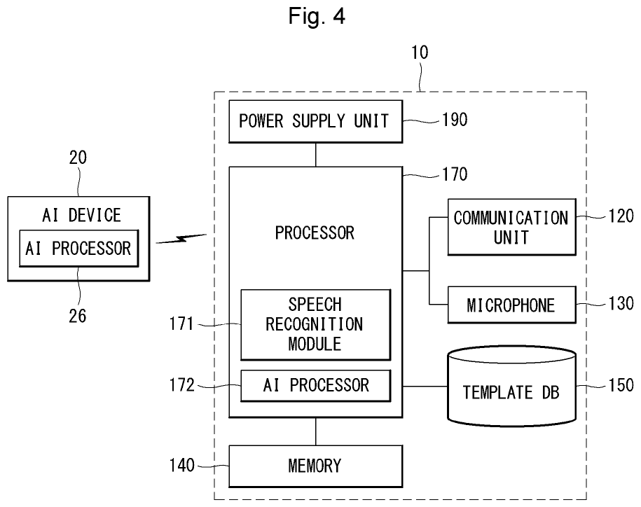

FIG. 4 is a block diagram illustrating a configuration of an electronic device having a voice recognition function according to an embodiment of the present invention.

Referring to FIG. 4, an electronic device 10 according to an embodiment of the present invention may be defined to a home appliance used in a home, for example, a device including a television, a refrigerator, a cleaner, a clothes dryer, an air conditioner and the like having artificial intelligence therein and/or a device including an autonomous vehicle, a connected car, a robot, and the like having a voice recognition function.

The electronic device 10 may have a SPEECH RECOGNITION MODULE 171 therein to recognize a user's voice command and to control an operation thereof accordingly.

Further, the electronic device 10 may include a communication module (not illustrated) to perform data communication with an AI device 20 functioning as a server based on 5G communication described with reference to FIGS. 1 to 3.

The AI device 20 may include an electronic device including an AI module that may perform AI processing or a server including the AI module. Further, the AI device 20 may include at least some components of the electronic device 10 to together perform at least some of AI processing.

AI processing of the AI device may understand/learn a meaning of the user's voice command based on data input to the electronic device 10 and perform a series of operation processes that output a result thereof.

Further, when the AI processing is included in the electronic device 10, the AI processing may include processing of data related to the operation control of the electronic device 10. For example, when the electronic device 10 is an autonomous vehicle, the electronic device 10 may perform AI processing of sensing data necessary for driving to perform processing/determination and control signal generation operations. Further, for example, the autonomous vehicle may perform AI processing of data obtained through an interaction with other electronic device provided in the vehicle to perform the autonomous driving control.

Further, when the electronic device 10 is a television, the electronic device 10 may recognize a wakeup word from the user's voice command and perform a series of data processing operations for controlling an operation of the television according to the user's voice command based on the wakeup word.

First, the AI device 10 may include an AI processor 26.

The AI processor 26 is a computing device that may learn a neural network and may be implemented into various electronic devices such as a server, a desktop PC, a notebook PC, and a tablet PC.

The AI processor 26 may learn a neural network using a program stored in a memory (not illustrated). In particular, the AI processor 26 may learn a neural network for recognizing the user's voice command. Here, the neural network for recognizing the user's voice command may be designed to simulate a human brain structure on a computer and include a plurality of network nodes having a weight and simulating a neuron of the human neural network. The plurality of network modes may exchange data according to each connection relationship so as to simulate a synaptic activity of neurons that send and receive signals through a synapse. Here, the neural network may include a deep learning model developed in the neural network model. In the deep learning model, while a plurality of network nodes is located in different layers, the plurality of network nodes may send and receive data according to a convolution connection relationship. An example of the neural network model includes various deep learning techniques such as deep neural networks (DNN), convolutional deep neural networks (CNN), Recurrent Boltzmann Machine (RNN), Restricted Boltzmann Machine (RBM), deep belief networks (DBN), and a deep Q-network and may be applied to the field of computer vision, speech recognition, natural language processing, and voice/signal processing.

The processor for performing the above-described function may be a general-purpose processor (e.g., CPU), but may be an AI dedicated processor (e.g., GPU) for learning AI.

The memory may store various programs and data necessary for an operation of the AI device 20. The memory may be implemented into a non-volatile memory, a volatile memory, a flash memory, a hard disk drive (HDD), or a solid state drive (SDD) and the like. The memory may be accessed by the AI processor 26 and read/write/modify/delete/update of data may be performed by the AI processor 26. Further, a memory 140 may store a neural network model for generating through learning algorithm for data classification/recognition according to an embodiment of the present invention to understand the user's voice command and to output a particular result value to perform a specific operation according to the voice command.

The AI processor 26 may include a data learning unit (not illustrated) for learning a neural network for data classification/recognition. The data learning unit may learn learning data to use in order to determine data classification/recognition and a criterion for classifying and recognizing data using learning data. By obtaining learning data to be used for learning and applying the obtained learning data to a deep learning model, the data learning unit may learn a deep learning model. Such learning data may be obtained from a plurality of electronic devices 10 connected to enable 5G communication, as described below. More accurately, the learning data may be used as identification information recorded in the template DB mounted in the electronic device 10. In this case, each electronic device 10 may periodically or aperiodically transmit identification information to the AI device 20 through 5G communication, and the AI device 20 may obtain identification information from the plurality of electronic devices 10 to train a neural network model. As a result, it is possible to understand more accurately the user's voice command and to control an operation accordingly.

The data learning unit may be produced in at least one hardware chip form to be mounted in the AI device 20. For example, the data learning unit may be produced in a dedicated hardware chip form for artificial intelligence (AI) and may be produced in a part of a general-purpose processor (CPU) or a graphic dedicated processor (GPU) to be mounted in the AI device 20. Further, the data learning unit may be implemented into a software module. When the data learning unit is implemented into a software module (or program module including an instruction), the software module may be stored in non-transitory computer readable media. In this case, at least one software module may be provided by an Operating System (OS) or may be provided by an application.

The data learning unit may include a learning data acquisition unit (not illustrated) and a model learning unit (not illustrated).

The learning data acquisition unit may obtain learning data necessary for a neural network model for classifying and recognizing data. For example, the learning data acquisition unit may obtain identification information for inputting to the neural network as learning data from the electronic device 10.

The model learning unit may learn to have a determination criterion in which a neural network model classifies predetermined data using the obtained learning data. In this case, the model learning unit may learn a neural network model through supervised learning that uses at least a portion of the learning data as a determination criterion. The model learning unit may learn the neural network model through unsupervised learning that finds a determination criterion by self-learning using learning data without supervision. Further, the model learning unit may learn the neural network model through reinforcement learning using feedback on whether a result of situation determination according to learning is correct. Further, the model learning unit may learn the neural network model using learning algorithm including error back-propagation or gradient decent.

When the neural network is learned, the model learning unit may store the learned neural network model in the memory. The model learning unit may store the learned neural network model at the memory of the server connected to the AI device 20 by a wired or wireless network.

In order to improve an analysis result of a recognition model or to save a resource or a time necessary for generation of the recognition model, the data learning unit may further include a learning data pre-processor (not illustrated) and a learning data selecting unit (not illustrated).

The learning data pre-processor may pre-process obtained data so that the obtained data may be used in learning for situation determination. For example, the learning data pre-processor may process the obtained data in a predetermined format so that the model learning unit uses obtained learning data for learning for image recognition.

Further, the learning data selection unit may select data necessary for learning among learning data obtained from the learning data obtaining unit or learning data pre-processed in the pre-processor. The selected learning data may be provided to the model learning unit.

Further, in order to improve an analysis result of the neural network model, the data learning unit may further include a model evaluation unit (not illustrated).

The model evaluation unit inputs evaluation data to the neural network model, and when an analysis result output from evaluation data does not satisfy predetermined criteria, the model evaluation unit may enable the model learning unit to learn again. In this case, the evaluation data may be data previously defined for evaluating a recognition model. For example, when the number or a proportion of evaluation data having inaccurate analysis results exceeds a predetermined threshold value among analysis results of a learned recognition model of evaluation data, the model evaluation unit may evaluate evaluation data as data that do not satisfy predetermined criteria.

The AI device 20 may further include a communication unit (not illustrated) to transmit an AI processing result by the AI processor 26 to the electronic device 10.

It has been described that the AI device of FIG. 4 is functionally divided into the AI processor 26, the memory, and the communication unit, but the above-mentioned components may be integrated into a single module to be referred to as an AI module.

The electronic device 10 may transmit data requiring AI processing to the AI device 20 through a communication unit 120, and the AI device 20 including the AI processor 26 may transmit an AI processing result using a deep learning model to the electronic device 10. Here, AI processing includes processing for speech recognition related to a user's voice command and processing for extracting a result thereof.

The electronic device 10 may include a memory 140, a processor 170, and a power supply unit 190, and the processor 170 may further include a speech recognition module 171 and an AI processor 172.

The memory 140 is electrically connected to the processor 170. The memory 140 may be used as a storage space for programs for implementing various functions of an electronic device and a template DB 150 for storing identification information to identify whether a recognized wakeup word is a voice generated by a user or a mechanical sound generated by the electronic device.

The memory 140 may store data processed in the processor 170. The memory 140 may be configured with at least one of a read-only memory (ROM), a random-access memory (RAM), an erasable programmable read only memory (EPROM), a flash drive, and a hard drive in hardware. The memory 140 may be implemented integrally with the processor 170. According to an embodiment, the memory 140 may be classified into a sub-configuration of the processor 170.

The power supply unit 190 may supply power to the electronic device 10. The power supply unit 190 may receive power from the outside or a built-in power source to supply power to each unit required for driving the electronic device 10.

The processor 170 may be electrically connected to each unit to exchange signals. The processor 170 may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electrical units for performing other functions.

The processor 170 may be driven by power supplied from the power supply unit 190. The processor 170 may receive data in a state in which power is supplied by the power supply unit 190, process the data, and generate and provide a signal.

The electronic device 10 may include at least one printed circuit board (PCB). Each unit including the processor 170 may be electrically connected to the printed circuit board.

The speech recognition module 171 may function to identify a wakeup word from a user's voice command or a received voice to individually perform a speech recognition operation based on a TTS or to perform a computational operation, as in the AI processor 172.

The AI processor 172 may be configured to have the same configuration as/a configuration similar to that of the AI processor 26 of the above-described AI device 20 to operate to recognize a wakeup word in a voice received from the outside of the device 10. A voice received from the outside of the device 10 through the microphone 130 may be input to the neural network (ANN) model trained to recognize the voice, and the wakeup word may be extracted from the voice received from an output of the neural network model.

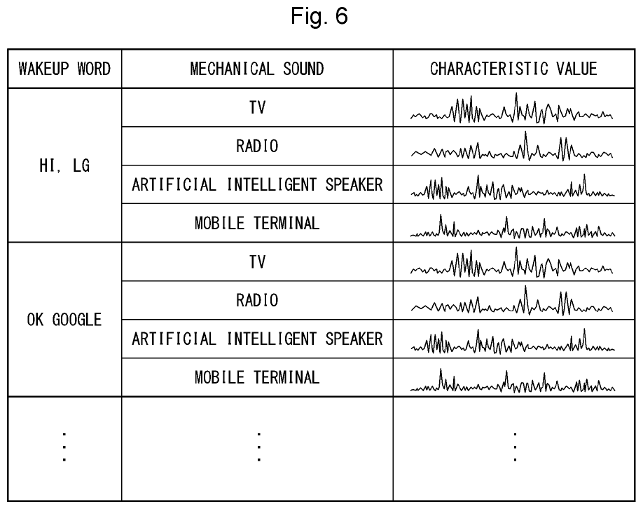

FIG. 6 is a flowchart illustrating a speech recognition method according to an embodiment of the present invention.

In an embodiment, the electronic device 10 may operate in a standby mode that recognizes a wakeup word and a speech recognition mode that performs an operation control according to speech recognition. Here, the wakeup word is a word for waking up a speech recognition service. The electronic device 10 may be configured to receive a peripheral sound through the microphone 130 in a standby mode and to enter to a speech recognition mode to perform the operation control according to the input voice when there is a wakeup word in the received voice.

The wakeup word may be variously set, and may be set by the user or at the factory. For example, a wakeup word of Google home may be set to a representative word such as ‘OK Google’, and a wakeup word of Apple may be set to a representative word such as ‘Alexa’, and similarly, a wakeup word for waking up a voice recognition service of the electronic device 10 may be set to ‘Hi, LG’.

The electronic device 10 operates in a standby mode in a turned-on state, receives a peripheral voice in the standby mode, and determines whether there is a wakeup word in the received voice. Whether a wakeup word exists in the received word may be determined based on classical speech recognition techniques such as TTS conversion or a neural network (ANN) model trained to recognize a human speech. The voice received through the microphone 130 may be transmitted to the AI processor 172 to be input to the neural network model, and a wakeup word may be extracted from the voice received from an output of the neural network model (S500).

The processor 170 calls and loads a speech analysis program from the memory 140, analyzes the extracted wakeup word according to the speech analysis program, and extracts a first characteristic value of the extracted wakeup word (S510). Here, the first characteristic value is data representing a sound characteristic of the extracted wakeup word and may represent the extracted wakeup word with a histogram showing a change in intensity of a sound in the order of time and a change in a frequency of a sound in the order of time.

The processor 170 compares the first characteristic value extracted in the previous step (S510) with identification information stored in the template DB 150 (S520). Here, comparison is a process of determining whether there is identification information matched to the first characteristic value, and for this reason, the identification information may include a second characteristic value that records a sound characteristic.

An example of the template DB 150 is shown in FIG. 6. The template DB 150 will be described with reference to FIG. 6.

The template DB 150 records a mechanical sound, i.e., a characteristic value (hereinafter, referred to as a second characteristic value) of a voice output through the electronic device. Here, the characteristic value is data obtained by the same manner as that of the first characteristic value and is data representing a sound characteristic of a wakeup word generated by a mechanical sound.

The template DB 150 may include a wakeup word field, a mechanical sound field, and a characteristic value field. Here, the wakeup word field is a field recording a wakeup word of devices operating by speech recognition. For example, the wakeup word field may record words for waking up a voice recognition service, such as “Hi, LG”, “Ok Google.” The mechanical sound field is a field recording a voice that generates a wakeup word by a mechanical sound. For example, the mechanical sound field is a field recording a wakeup word of “Hi, LG” generated by an electronic device such as a television, a radio, an artificial intelligence speaker, or a mobile terminal. The characteristic value field is a field recording a sound characteristic of each mechanical sound, and because sounds generated by each electronic device are different, the characteristic value may operate as a voice print.

In step S520, the processor 170 reads a second characteristic value stored in the template DB 150 to compare the second characteristic value with a first characteristic value obtained from the extracted wakeup word. Here, comparison does not necessarily mean 100% match, and a comparison result may be output according to predetermined conditions. For example, when similarity between the first characteristic value and the second characteristic value is 90% or more, it may be determined that the first characteristic value and the second characteristic value are the same.

As a comparative result of step S530, when the second characteristic value is the same as the first characteristic value, the processor 170 controls the electronic device 10 to operate in a standby mode (S540), and if the first characteristic value is not the same as the second characteristic value, the processor 170 activates the speech recognition module 171 to controls the electronic device 10 to operate in a speech recognition mode (S530).

According to an embodiment of the present invention, when the electronic device 10 receives an input of a wakeup word, the electronic device 10 may identify whether a wakeup word input by a user instead of immediately performing a speech recognition operation according to the wakeup word or a wakeup word generated in an electronic device and thus the electronic device may be prevented from erroneously operating regardless of the user's intention.

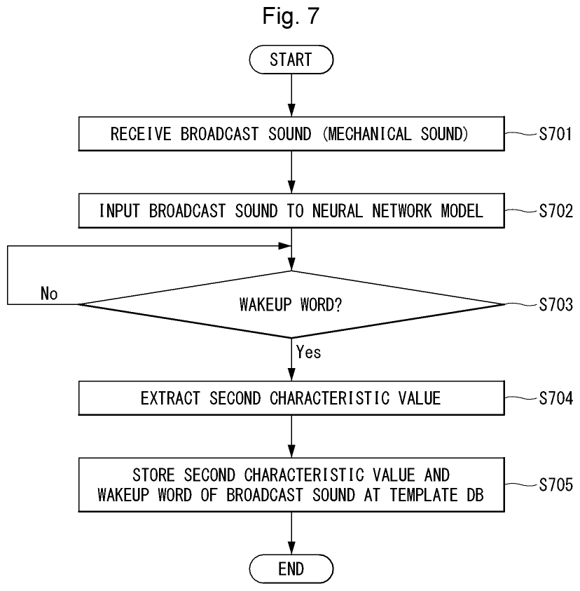

FIG. 7 is a diagram illustrating a process of updating a template DB. In an embodiment of the present invention, the template DB may be updated periodically or aperiodically through a broadcast sound. Here, the broadcast sound indicates a broadcast sound output from an imaging device such as a television.

The electronic device 10 may be set to operate by further including a training mode for updating the template DB. The training mode is a mode that performs an operation for only updating the template DB is performed while limiting an operation of the electronic device 10 or the electronic device 10 may be set to operate a training mode in a background while performing a normal operation.

In step S701, the processor 170 operates to activate the microphone 130 to receive a periphery voice. Here, the peripheral sound means a mechanical sound output through a speaker such as a television or an intelligent speaker and may be more accurately a broadcast sound output by a mechanical sound.

In step S702, the received broadcast sound may be input to the neural network model of the AI processor 172, and it is determined whether a wakeup word exists in the received broadcast sound, as described above. Here, a wakeup word identified by the AI processor 172 may be identified by training or may be defined to a default value set when an electronic device is launched from a factory.

When the wakeup word is determined as the determination result of step S703, the AI processor 172 may extract a wakeup word from a received broadcast sound to notify a fact thereof to the processor 170. The processor 170, having received a result value extracts a second characteristic value using a histogram or frequency analysis in order to extract characteristics of the corresponding wakeup word (S704).

In step S705, the extracted second characteristic value and wakeup word are additionally stored at the template DB 150 as identification information and thus the template DB 150 may be updated.

Accordingly, by more accurately recognizing whether the recognized wakeup word is generated by the user or is generated by the electronic device, the electronic device may be prevented from erroneously operating.

Further, updating of the template DB is performed for a predetermined time in a training mode or is performed in a background during an operation of the electronic device and thus whenever a new wakeup word that is not stored in the template DB is recognized, the template DB may be updated.

The present invention may be implemented as a computer readable code in a program recording medium. The computer readable medium includes all kinds of record devices that store data that may be read by a computer system. The computer readable medium may include, for example, a Hard Disk Drive (HDD), a Solid State Disk (SSD), a Silicon Disk Drive (SDD), a read-only memory (ROM), a random-access memory (RAM), a compact disc read-only memory (CD-ROM), a magnetic tape, a floppy disk, an optical data storage device and the like and also include a medium implemented in the form of a carrier wave (e.g., transmission through Internet). Accordingly, the detailed description should not be construed as being limitative from all aspects, but should be construed as being illustrative. The scope of the present invention should be determined by reasonable analysis of the attached claims, and all changes within the equivalent range of the present invention are included in the scope of the present invention.

1. A method of recognizing a voice in a speech recognition device, the method comprising:
receiving a wakeup word in a standby mode;
extracting a first characteristic value representing a voice characteristic of the wakeup word from the received word and comparing the extracted first characteristic value with a template DB;
wherein the template DB stores identification information comprising a wakeup word made with a mechanical sound and a second characteristic value representing a voice characteristic of the mechanical sound, and
entering, if the template DB does not store the second characteristic value matched to the first characteristic value, a speech recognition mode for speech recognition of a speaker and entering, if the template DB stores the second characteristic value matched to the first characteristic value, the standby mode.

2. The method of claim 1, wherein the receiving of a wakeup word comprises receiving a peripheral voice through a microphone to input the received voice to a neural network (ANN) model trained to recognize the voice and extracting the wakeup word from the received voice from an output of the ANN model.

3. The method of claim 1, wherein the receiving of a wakeup word comprises updating the template DB by further comprising:
extracting, when the wakeup word is recognized in the mechanical sound, the second characteristic value from the wakeup word of the recognized mechanical sound; and
matching the extracted second characteristic value to the wakeup word of the mechanical sound and storing the matched second characteristic value at the template DB.

4. The method of claim 1, wherein the mechanical sound is a voice output from the electronic device.

5. The method of claim 4, wherein the electronic device comprises at least one of a speech recognition speaker, a television, and a radio.

6. The method of claim 1, wherein the speech recognition device is accessed to an AI device through a 5G wireless communication system that provides a 5^{TH} Generation (5G) service,
wherein the 5G service comprises a Massive Machine-type Communication (mMTC) service, and transmits voice data received in the speech recognition mode to the AI device through an MTC Physical Uplink Shared Channel (MPUSCH) and/or an MTC Physical Uplink Control Channel (MPUCCH), which are/is a physical resource provided through the mMTC service.

7. The method of claim 6, wherein the 5G wireless communication system provides a system bandwidth related to some resource blocks thereof and comprises a Narrowband-Internet of Things (NB-IoT) system that provides the mMTC service, performs an initial access procedure to the 5G wireless communication system through an anchor type carrier related to the NB-IoT system, and transmits voice data received in the speech recognition mode to the AI device through a non-anchor type carrier related to the NB-IoT system.

8. A speech recognition device, comprising:
a template DB for storing identification information comprising a wakeup word made with a mechanical sound and a second characteristic value representing a voice characteristic of the mechanical sound;
a microphone for receiving a voice;
a processor; and
a memory for storing instructions that may be executed by the processor, wherein the processor is configured to:
receive a wakeup word through the microphone in a standby mode;
extract a first characteristic value from the received wakeup word; and
compare a first characteristic value of the extracted wakeup word with the template DB, control to enter to a speech recognition mode for voice recognition of a speaker, if the template DB does not store the second characteristic value corresponding to the first characteristic value, and to enter to the standby mode, if the template DB stores the second characteristic value corresponding to the first characteristic value.

9. The speech recognition device of claim 8, wherein the processor receives a peripheral voice to input the peripheral voice to a neural network (ANN) model trained to recognize a voice and extracts the wakeup word from the received peripheral voice from an output of the ANN model.

10. The speech recognition device of claim 8, wherein the processor is configured to:
receive a mechanical sound through the microphone;
extract the second characteristic value from the wakeup word of the recognized mechanical sound when the wakeup word is recognized in the received mechanical sound; and
update the template DB by matching the extracted second characteristic value to the wakeup word of the mechanical sound and storing the matched second characteristic value in the template DB.
